(19) United States
(12) Patent Application Publication
(10) Pub. No.: US 2026/0254834 A1
(43) Pub. Date: Aug. 27, 2026

(54) DEVICE SECURITY WITH ONLINE CONFIGURATION CHECK

(71) Applicant: International Business Machines Corporation, Armonk, NY (US)

(72) Inventors: Plamen Danov, Sofia (BG); Martin Grigorov Marinov, Pernik (BG)

(21) Appl. No.: 19/077,797

(22) Filed: Mar. 12, 2025

(30) Foreign Application Priority Data
Feb. 27, 2025 (GB) 2502835.8

(51) Int. Cl. H04L 9/40

(52) U.S. Cl. CPC H04L 63/1433

(57) ABSTRACT

According to one embodiment, computer-implemented method, a system, and a computer program product for security validation of a network device in a networked computing environment is disclosed. The embodiment may include receiving information about a security vulnerability of a network device, filtering the received information to identify a specific security vulnerability associated with the network device, and extracting a command based on the filtered information, where a returned response of the command when executed is indicative of a specific vulnerability impacting an operation of the network device. The embodiment may include generating a report specifying at least one detail of the network device being affected by a known vulnerability and generating an alert signal indicative of the device security vulnerability status.

### BACKGROUND

Invention aspects relate generally to a computer-implemented method for network security, and more specifically, to a computer-implemented method for security validation of a network device in a networked computing environment. The invention aspects relate further to a related device security system for a security validation of a network device in a networked computing environment, and a related computer program product.

Nowadays, computer infrastructure security remains one of the top three priorities of information technology (IT) organizations and executives. Very often, software assurance tools are used to identify possible vulnerabilities of potential malicious code and software systems, including commercial-off-the-shelf (COTS) software systems. On the other side, vendors of operating systems for computer systems also perform regular security checks and may inform customers using the operating systems about potential security threats. Nevertheless, cyberattacks have become a regular problem because it is never possible to predict from which direction and with which technology the next cyberattack might come. In addition, growing technical and security risks may also entail financial and/or reputation risks. Therefore, issues surrounding cyberattacks have found their way into companies’ risk management.

According to one aspect of the present invention, a computer-implemented method for security validation of a network device in a networked computing environment may be provided. The method may comprise receiving information about a security vulnerability of a network device, filtering the received information to identify a specific security vulnerability associated with the network device, and extracting a command based on the filtered information. When executed, a returned response of the executed command may indicate a specific vulnerability that impacts an operation of the network device. Additionally, the method may comprise generating a report specifying at least one detail of the network device being affected by a known vulnerability and generating an alert signal indicative of the device security vulnerability status.

According to another aspect of the present invention, a device security system for a security validation of a network device in a networked computing environment may be provided. The system may comprise a processor and a memory, communicatively coupled to the processor, wherein the memory stores program code portions that when executed, enable the processor, to receive information about a security vulnerability of a network device, filter the received information to identify a specific security vulnerability associated with the network device, and extract a command based on the filtered information where a returned response of the executed command when executed is indicative of a specific vulnerability impacting an operation of the network device. The processor may also be enabled to generate a report specifying at least one detail of the network device being affected by a known vulnerability and generate an alert signal indicative of the device security vulnerability status.

Furthermore, embodiments may take the form of a related computer program product, accessible from a computer-usable or computer-readable medium that, provides program code for use by or in connection with a computer or any instruction execution system by or in connection with a computer or any instruction execution system. The program code configured to implement the computer-implemented method of the above embodiment. For the purposes of this description, a computer-usable or computer-readable medium may be any apparatus that may contain means for storing, communicating, propagating or transporting the program for use by or in connection with the instruction execution system, apparatus, or device.

It should be noted that embodiments of the present invention are described with reference to different subject-matters. In particular, some embodiments are described with reference to method-type claims, whereas other embodiments are described with reference to apparatus-type claims. However, a person skilled in the art will understand from the above and the following description that, unless otherwise indicated, in addition to any combination of features belonging to one type of subject-matter, also any combination between features relating to different subject-matters, in particular, between features of the method-type claims, and features of the apparatus-type claims, is also considered to be disclosed by this document.

These and other objects, features and advantages of the present invention will become apparent from the following detailed description of illustrative embodiments thereof, which is to be read in connection with the accompanying drawings.

Preferred embodiments of the inventive concept are described, by way of example only, and with reference to the following drawings to which the inventive concept – for which variations and at least partial substitutions exist – is not limited. In the drawings:

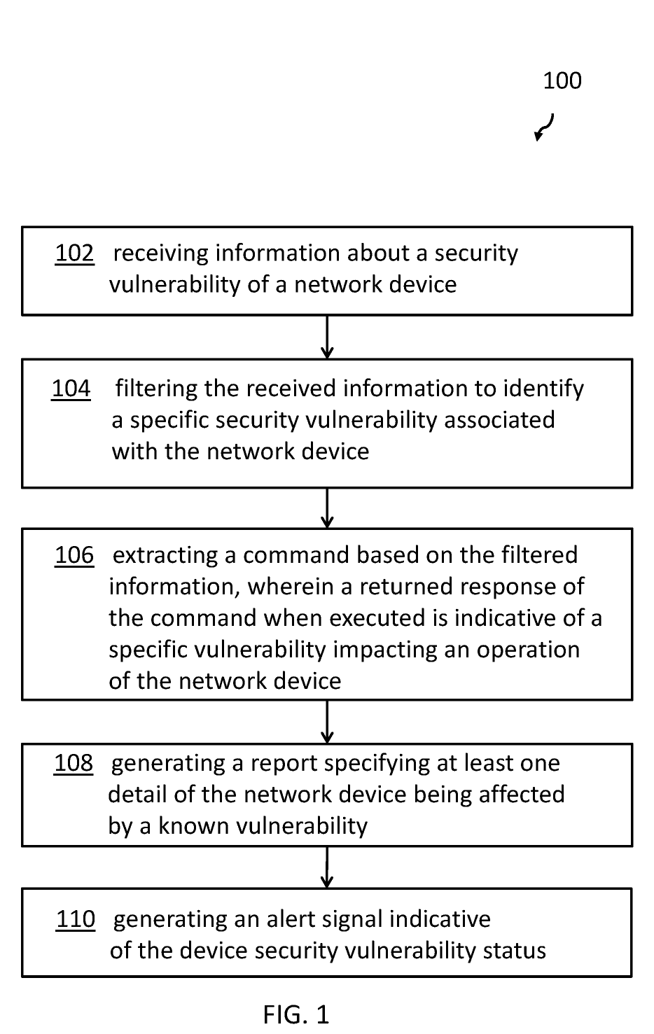

FIG. 1 shows a flowchart of an embodiment of the inventive computer-implemented method for security validation of a network device in a networked computing environment.

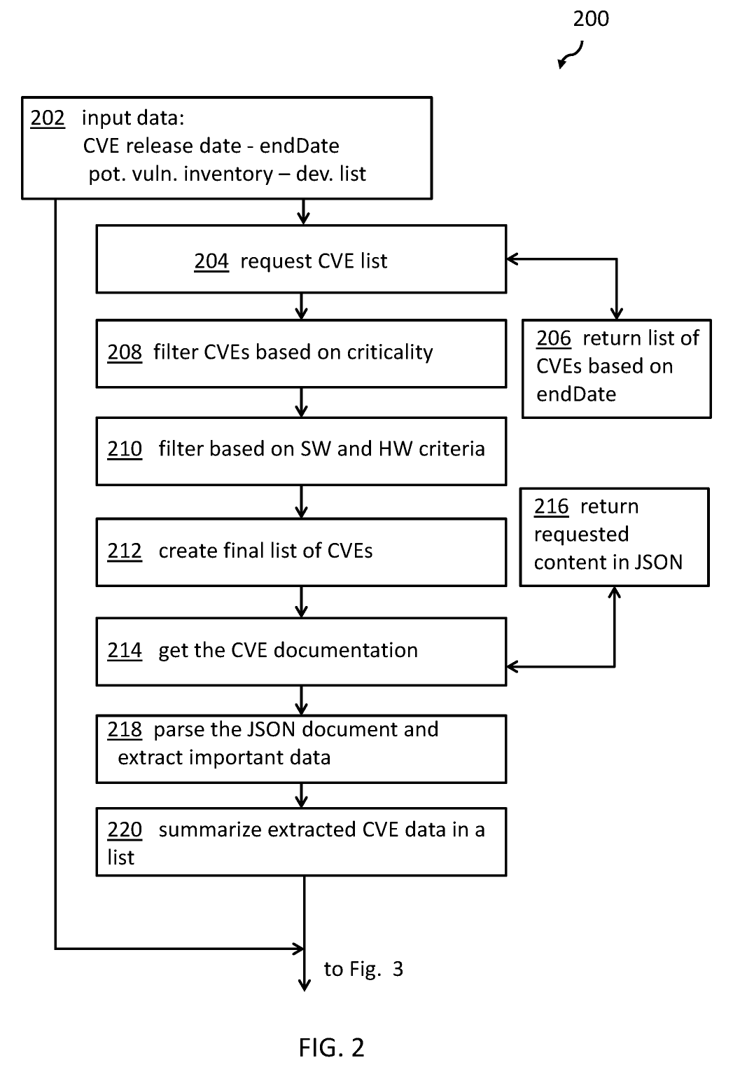

FIG. 2 shows a flowchart of a first part of a more detailed flow diagram.

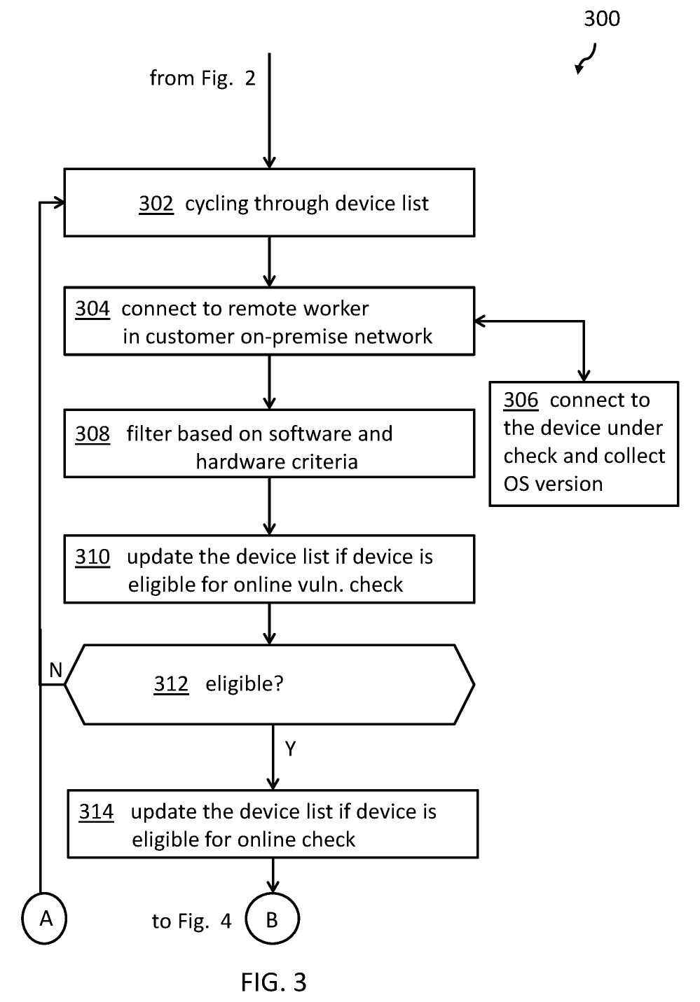

FIG. 3 shows a flowchart of a second portion of the more detailed flow diagram of FIG. 2.

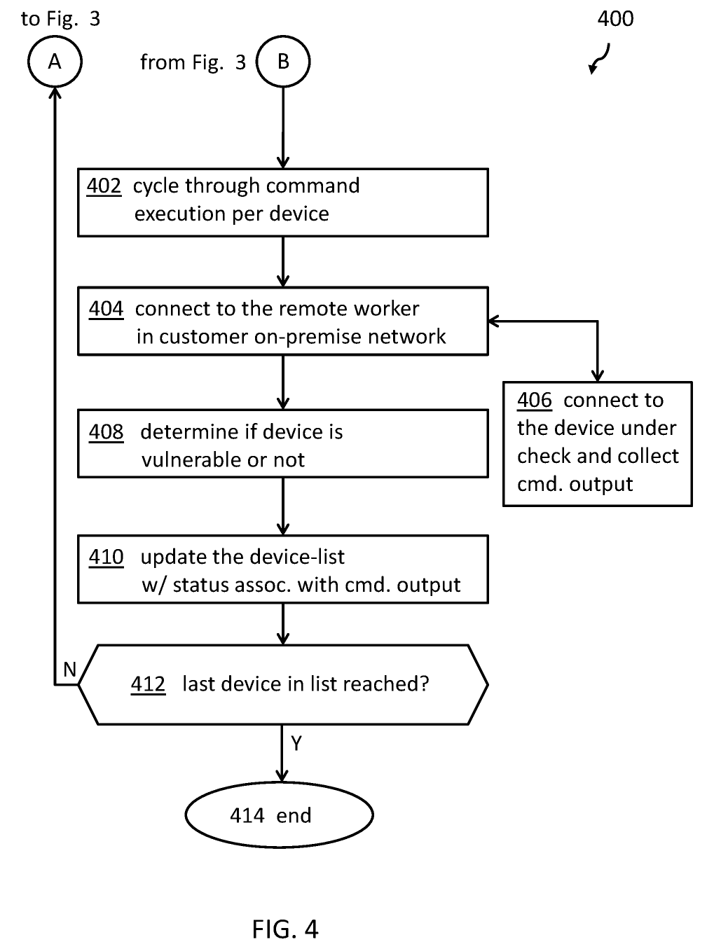

FIG. 4 shows a flowchart of a third portion of the more detailed flow diagram of FIGS. 2 and 3.

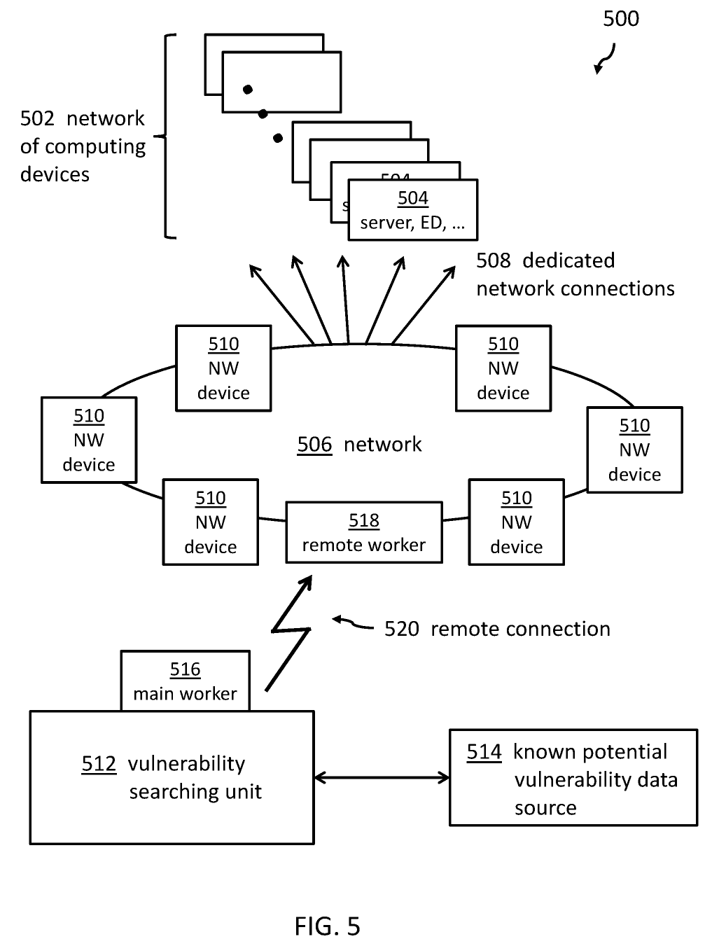

FIG. 5 shows a block diagram of an architecture of a computing environment to execute the inventive method.

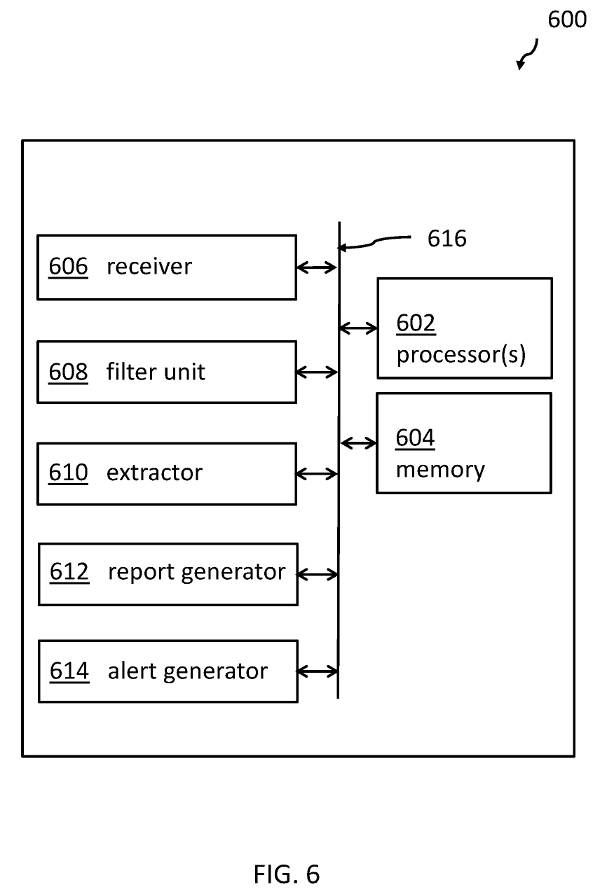

FIG. 6 shows a block diagram of an embodiment of the inventive device security system for a security validation of a network device in a networked computing environment.

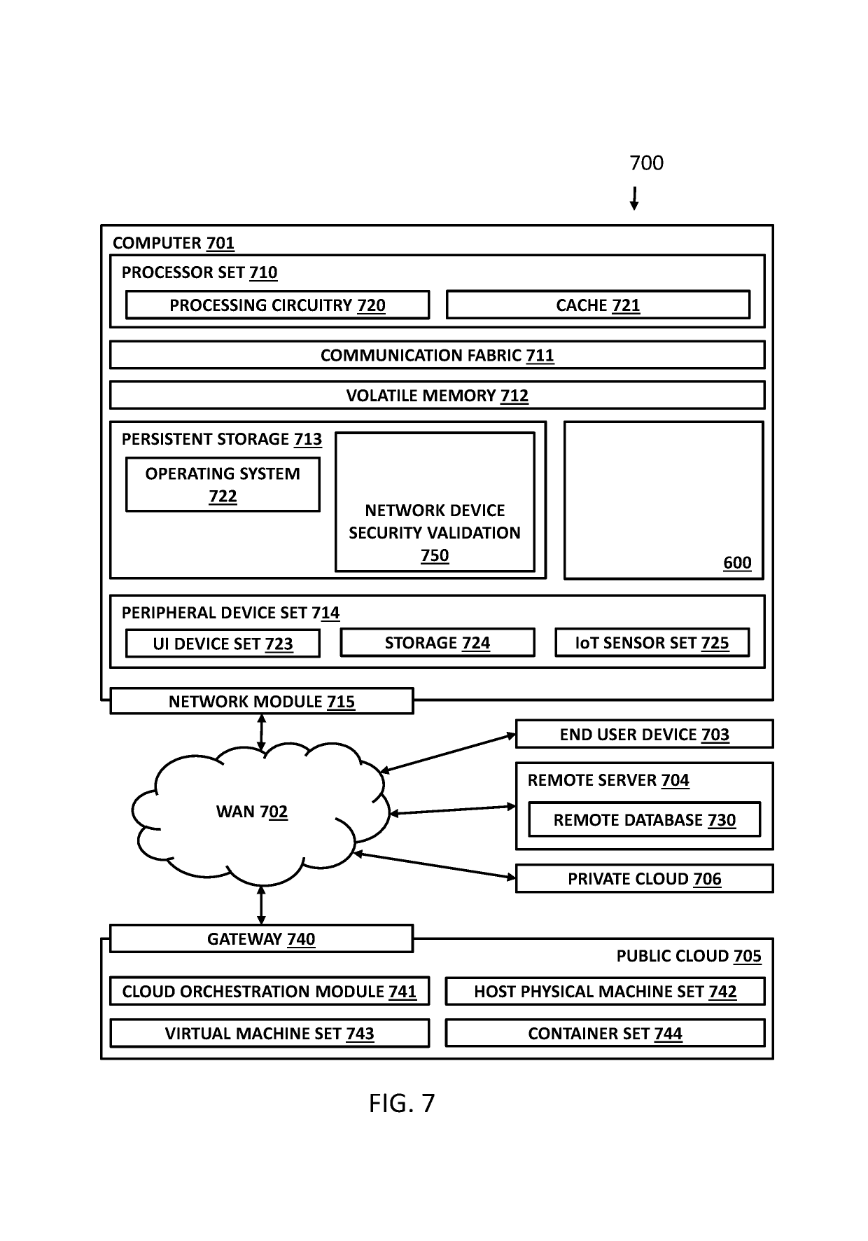

FIG. 7 shows an embodiment of a computing system comprising the system according to FIG. 6.

### DETAILED DESCRIPTION

As previously stated, computer infrastructure security remains one of the top three priorities of information technology (IT) organizations and executives. Very often, software assurance tools are used to identify possible vulnerabilities of potential malicious code and software systems, including commercial-off-the-shelf (COTS) software systems. On the other side, vendors of operating systems for computer systems also perform regular security checks and may inform customers using the operating systems about potential security threats. Nevertheless, cyberattacks have become a regular problem because it is never possible to predict from which direction and with which technology the next cyberattack might come. In addition, growing technical and security risks may also entail financial and/or reputation risks. Therefore, issues surrounding cyberattacks have found their way into companies’ risk management.

Additionally, more and more devices are going online, including many consumer devices, autonomous cars, industrial process controlling components, and sensors in private environments. This “going online” is an increasing trend. This requires network devices that control, regulate, and secure the flow of information between the various components of the Internet. Consequently, the number of vulnerabilities and related attacks has increased exponentially year after year.

This increases the company’s risk to be hacked and have its normal work process adversely affected. Any work process outage could lead to significant financial and/or reputational losses for the attacked organization.

As a countermeasure, vendors of network devices regularly publish reports on new known vulnerabilities. These reports can help organizations to mitigate risk but, on the other hand, add significant workloads to the networking teams. Assessments regarding individual network devices require time-consuming manual configuration checks because checking the operating system of the network device may not be enough. Sometimes, the network devices can have configurable operating system versions in which a specific feature could be disabled.

In this context, some documents have already been published. For example, document US 11,863,333 B1 describes cybersecurity and threat assessment platforms for computing environments. It comprises the ability to use automated techniques for analyzing the effects of cyber security threats on a system or collection of systems. The analyzing comprises also modeling and simulation techniques. Thereby, a hierarchical modeling framework to describe the characteristics of an attack and a target system in question is used, thereby creating a model that can be used to describe possible interaction between attack systems and defense systems. Additionally, document US 2019/0238584 A1 describes a system and a method for vulnerability management for connected devices. Thereby, vulnerabilities are identified using one or more rules, as well as, using a vulnerability score by assigning weights to an impact metric and an exploitability metric.

However, there remains a need to increase the robustness and/or resilience against cyberattacks especially in the case of those “invisible” devices controlling the network traffic, i.e., network devices.

In the context of this description, the following technical conventions, terms and/or expressions may be used:

The term 'security validation' may denote an investigation of a network device in a dedicated computing environment, i.e., network of networked devices, for determining whether the network device is configured or may be configured in a way to represent a vulnerability for the device and/or the dedicated computing environment. If no such vulnerability is found, the network device may be classified as secure, i.e., it has undergone a security validation for the current moment in time. Security validation should be made in regular time intervals.

As is well known in technology, security attacks on network devices can occur in different phases or waves. Thereby, a little modification of the implementation of the network device can be the base for another little modification of the network device and so on (also denoted as device security kill chain). Thus, over time a real threat may be created which may allow an external infiltration of the network. As such, the above-mentioned security validation may also determine little modifications of the implementation of the network device in early stages, i.e., in early modification steps.

The term 'network device' may denote here a switch, a router, a firewall or a gateway. This may comprise principally all devices – either in hardware or virtualized – required and used for operating a network of computer systems. Additionally, servers and end-user devices like a personal computer (PC) or any mobile device, connected wirelessly or wired, may be operated like the above-mentioned devices. However, for servers and end-user devices typically other vulnerability scanners may be used.

The term 'networked computing environment' may denote a network of computing devices, in particular network devices managing the function of the network – i.e., the exchange of data among the networked devices – but also servers and other computing devices connected to the network. The connections between the different nodes of the network may be wired or wireless or a mixture thereof. Thereby, a node is any device connected to or with the network of computer systems.

The term 'information about a security vulnerability' may denote any data available about potential threats and/or security attacks directed to a network device. This may also include the potential to change a configuration of a network device – including its operating or control system – in a way to represent a potential threat, attack or exposure to/of the network and its network devices and/or other connected computing devices.

The term 'specific security vulnerability' may denote a dedicated known potential threat and/or attack method against a network device. Such a specific security vulnerability may be determined using a specific known command to be executed by the network device and/or its operating and/or control system and measuring a corresponding response to the command. Based on this, it can be determined whether the network device can be classified as secure or not.

The term 'command based on the filtered information' may denote that a command or an instruction or similar, to be executed by the network device and/or its operating or control system, has been determined based on the information received that has been filtered for a specific security vulnerability and its related command to identify the specific security vulnerability. Thereby, the term 'command' may be any digital string (human and/or only machine readable) resulting in a digital response when interacting with a target. The target may be any part or portion of the network device, e.g., its hardware, machine code, application program interface of any kind, command interpreter, web interface or any other command receiving interaction surface.

The term 'returned response' may denote data to be received as an answer of an executed command that the network device and/or its operating or control system has executed.

The term 'report' may denote here a summary of potential security threats and/or vulnerabilities to network devices with respect to the network devices of a networked computing environment. The report may be prepared in a human and/or machine-readable form.

Embodiments of the inventive concept can be described as follows. They may be applicable for the proposed method as well as for the proposed system and the proposed computer program product.

According to one embodiment of the present invention, a computer-implemented method for security validation of a network device in a networked computing environment is provided. The method may comprise receiving information about a security vulnerability of a network device, filtering the received information to identify a specific security vulnerability associated with the network device, and extracting a command based on the filtered information, where a returned response of the command when executed is indicative of a specific vulnerability impacting an operation of the network device. Furthermore, the method comprises generating a report specifying at least one detail of the network device being affected by a known vulnerability and generating an alert signal indicative of the device security vulnerability status.

According to another embodiment of the present invention, a device security system for a security validation of a network device in a networked computing environment may be provided. The system may comprise a processor and a memory, communicatively coupled to the processor, wherein the memory stores program code portions that when executed, enable the processor, to receive information about a security vulnerability of a network device, filter the received information to identify a specific security vulnerability associated with the network device, and extract a command based on the filtered information, where a returned response of the command when executed is indicative of a specific vulnerability impacting an operation of the network device. Moreover, the processor is also enabled to generate a report specifying at least one detail of the network device being affected by a known vulnerability; and generate an alert signal indicative of the device security vulnerability status.

The proposed computer-implemented method for security validation of a network device in a networked computing environment may offer multiple advantages, technical effects, contributions and/or improvements:

Basically, a fully automated flow for conducting security vulnerability checks for a plurality of network devices may be implemented. Additionally, a complete vulnerability report for a network may be generated. This technology may not only work on-site but also in a remote way. Thereby, a plurality of different networked computing environments may be surveyed autonomously and in an automated fashion. As a basis, publicly known information as well as trusted data from a vendor of the network device may be used.

Cyber-attacks are often sensitive to time for counter actions. Therefore, the highly efficient, safe and organized method to identify potential vulnerabilities, as proposed by the present invention, may help to mitigate risks regarding a specific network computing environment.

Additionally, the proposed method may allow for specific action regarding a new vulnerability. This is because for each vulnerability, isolated documents are available which can be checked automatically and which may contain embedded commands that may be used to target only specific network devices and/or sub-systems or sub-functions of a related network device operating system thereof. This may save network and other resources to protect network infrastructures against cyber-attacks, as well as industrial espionage.

Overall, the proposed method avoids the time-consuming manual configuration check of network devices which may often take longer than the arrival of new threats. Hence, the inability to have a complete network vulnerability check without using the manual method can be overcome.

In the following, additional embodiments of the inventive concept – applicable for the method as well as for the system and the computer program product– will be described.

According to a useful embodiment of the method, the network computing environment may comprise a plurality of network devices, and the steps of receiving information, filtering the received information, extracting the command, generating the report, and generating an alert signal may be performed for the plurality of the networked devices of the networked computing environment. Using this approach, a complete network infrastructure – i.e., all its network components – can be scanned for malicious code and all functions, i.e., vulnerabilities and/or exposures.

According to an interesting embodiment of the method, the network device or the networked devices may contain at least one out of the group comprising a router, a switch, a firewall and a gateway, and potentially also other devices. I.e., different types of network equipment may be scanned for vulnerabilities. This may also apply to modems, NAS (network attached storage devices), servers as well as any type of end-user equipment.

According to an advantageous embodiment of the method, the impacted operation of the network device may be associated with a feature of an operating system or control system of the network device. Thereby, the feature of the operating system may be enabled or disabled; it depends on the type of vulnerability in question.

According to another advantageous embodiment, the method may also comprise receiving the information about a security vulnerability from a vendor of the network device or another a trusted public source. The trusted public source may exist in the form of a collaboration initiative between a plurality of different IT security constituents or a consortium for IT security or, a government agency. They may share observed problems in networks due to network attacks and all other security issues. The vendor of the network device may be one party of the trusted public source.

According to a preferred embodiment, the method may also comprise performing the method for security vulnerability of a network device using a vulnerability check engine operated remotely with respect to the networked computing environment. For this, it is useful to rely on trusted software code implemented for a remotely operated, vulnerability check engine as well as, for a hardware/software combination operated apart from the network environment under investigation. This may allow security service partners to check a network environment from a (central) operations center. The networked computing environment may be operated remotely in respect to the operations center by an entity owning the related network devices of the networked computing environment. This way, service organizations may perform the vulnerability check as a service for the owner of the networked computing environment.

According to an enhanced embodiment, the method may also comprise executing the extracted command based on the filtered information using an application programming interface (API) of the networked device. This may be done via an encrypted access protocol, e.g., HTTPS (e.g., port 443), secure shell (SSH), a remote worker software (or hardware/software communication) responsible for the communication to the networked device. Thereby, the remote worker can be a logical extension of the vulnerability check engine.

According to a permissive embodiment of the method, the execution of the extracted command based on the filtered information may be performed in parallel for each network device of a plurality of network devices in the networked computing environment. This may allow to perform multiple vulnerability checks in parallel. Thereby, a sort of vulnerability snapshot may be generated.

According to a preferred embodiment of the method, a separate document may exist for each identified vulnerability of a plurality of security vulnerabilities. This may allow a clear separation between different network devices and single vulnerabilities.

According to an optional embodiment of the method, network devices of the networked computing environment may be located in at least two different geographical locations. By this, a network device may be located at another geographical location having its own networked computing environment as a sub-network. This second networked computing environment may be a logical extension of the original networked computing environment.

The present subject matter may comprise the following clauses.

Clause 1. A computer-implemented method for security validation of a network device in a networked computing environment, the method comprising: receiving information about a security vulnerability of a network device; filtering the received information to identify a specific security vulnerability associated with the network device; extracting a command based on the filtered received information, wherein a returned response of the command when executed is indicative of a specific vulnerability impacting an operation of the network device; generating a report specifying at least one detail of the network device being affected by a known vulnerability; and generating an alert signal indicative of the device security vulnerability status.

Clause 2. The method of clause 1, wherein the networked computing environment comprises a plurality of network devices, and wherein the steps of receiving information, filtering the received information, extracting the command, generating the report, and generating an alert signal is performed for each network device of the plurality of the networked devices of the networked computing environment.

Clause 3. The method of any of the preceding clauses 1 to 2, wherein the network device or the plurality of network devices contains at least one out of the group comprising a router, a switch, and a firewall.

Clause 4. The method of any of the preceding clauses 1 to 3, wherein the specific vulnerability impacting the operation of the network device is associated with a feature of an operating system of the network device.

Clause 5. The method of any of the preceding clauses 1 to 4, further comprising: receiving the information about the security vulnerability from a vendor of the network device or a trusted public source.

Clause 6. The method of any of the preceding clauses 1 to 5, wherein the receiving, the filtering, the extracting, generating the report, and generating the alert signal is performed using a vulnerability checking engine operated remotely with respect to the networked computing environment.

Clause 7. The method of any of the preceding clauses 1 to 6, further comprising: executing the command based on the filtered information using an application programming interface of the networked device.

Clause 8. The method of clause 2, wherein execution of the command based on the filtered information is performed in parallel for each network device of the plurality of network devices.

Clause 9. The method of any of the preceding clauses 1 to 8, wherein a separate document exists for each identified vulnerability of a plurality of security vulnerabilities.

Clause 10. The method of any of the preceding clauses 1 to 9, wherein network devices of the networked computing environment are located in at least two different geographic locations.

Clause 11. A device security system for a security validation of a network device in a networked computing environment, the system comprising: one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising: receiving information about a security vulnerability of a network device; filtering the received information to identify a specific security vulnerability associated with the network device; extracting a command based on the filtered received information, wherein a returned response of the command when executed is indicative of a specific vulnerability impacting an operation of the network device; generating a report specifying at least one detail of the network device being affected by a known vulnerability; and generating an alert signal indicative of the device security vulnerability status.

Clause 12. The system of clause 11, wherein the networked computing environment comprises a plurality of network devices, and wherein the receiving, the filtering, the extracting, generating the report, and generating the alert signal is performed for each network device of the plurality.

Clause 13. The system of any of the preceding clauses 11 to 12, wherein the network device or the plurality of network devices contains at least one out of the group comprising a router, a switch, and a firewall.

Clause 14. The system of any of the preceding clauses 11 to 13, wherein the specific vulnerability impacting the operation of the network device is associated with a feature of an operating system of the network device.

Clause 15. The system of any of the preceding clauses 11 to 14, further comprising: receiving the information about the security vulnerability from a vendor of the network device or a trusted public source.

Clause 16. The system of any of the preceding clauses 11 to 15, wherein the receiving, the filtering, the extracting, generating the report, and generating the alert signal is performed using a vulnerability checking engine operated remotely with respect to the networked computing environment.

Clause 17. The system of any of the preceding clauses 11 to 16, further comprising: executing the command based on the filtered information using an application programming interface of the networked device.

Clause 18. The system of clause 17, wherein execution of the command based on the filtered information is performed in parallel for each network device of the plurality of network devices.

Clause 19. The system of any of the preceding clauses 11 to 18, wherein a separate document exists for each identified vulnerability of a plurality of security vulnerabilities.

Clause 20. A computer program product for a security validation of a network device in a net-worked computing environment, the computer program product comprising one or more computer readable storage medium and program instructions stored on at least one of the one or more computer readable storage medium, the program instructions executable by a processor capable of performing a method, the method comprising: receiving information about a security vulnerability of a network device; filtering the received information to identify a specific security vulnerability associated with the network device; extracting a command based on the filtered received information, wherein a returned response of the command when executed is indicative of a specific vulnerability impacting an operation of the network device; generating a report specifying at least one detail of the network device being affected by a known vulnerability; and generating an alert signal indicative of the device security vulnerability status.

In the following, a detailed description of the figures will be given. All instructions in the figures are schematic. Firstly, a block diagram of an embodiment of the inventive computer-implemented method for security validation of a network device in a networked computing environment is given. Afterwards, further embodiments as well as embodiments of the device security system for a security validation of a network device in a networked computing environment will be described.

FIG. 1 shows a flowchart of a preferred embodiment of the computer-implemented method 100 for security validation of a network device in a networked computing environment. The network device is typically a plurality of routers, switches, and/or firewalls. Typically, different vulnerabilities are exploited on servers by intruders to attack specific characteristics of the servers and their operating systems. In general, however, the proposed method and the associated system may also be used for services and other devices connected to the network. Additionally, the network computing environment may be associated with one or more geographical locations and computing and/or network sites connected with wide area networks.

The method 100 comprises receiving, at 102, information about a security vulnerability of a network device. The information may be publicly available data, e.g., from the vendor of the network device. In some cases, the information may also be included in comprehensive vulnerability reports.

The method 100 may also comprise filtering, at 104, the received information to identify a specific security vulnerability associated with the network device. This task can be performed by a specific vulnerability checking engine and by searching through the – in many cases – unstructured text document(s). The search can be based on a regular expression (regex) and/or comparisons with known terms. Alternatively, a dedicated trained machine learning system may also be instrumental for this task.

Additionally, the method 100 also comprises extracting, at 106, a command based on the filtered information, where a returned response of the command when executed is indicative of a specific vulnerability impacting an operation of the network device. In particular, a specific feature or function of the operating system or control system of the network device can be targeted by an intruder. This is the preferred mode of operation because typically, each vulnerability may be described in a single document in which also the required test may be named and/or described.

Next, the method 100 also comprises generating, at 108, a report specifying at least one detail of the network device being affected by a known vulnerability. The detail may be the operating version used, specific feature of the operating system and whether the feature is used in the current configuration. Therefore, the report may comprise a detailed configuration of the network device. The report may indicate that the same vulnerability may also exists on other network devices. Or it may indicate that one type of network device has one vulnerability, but the type of network device is used several times in the network. The report may indicate the severity of the vulnerability concerning the functioning of the network. The report may comprise a prioritizing of the different identified vulnerabilities of the network devices or a prioritization of the network devices having different identified vulnerability. The user may also take action against selected vulnerabilities – e.g., more severe or high priority vulnerabilities or the prioritized network devices having a predefined identified vulnerability. The report can also have recommended instruction(s) for a system operator for countermeasures against the existing vulnerability. Alternatively, the instruction(s) may be executed automatically in order to eliminate the vulnerability. Reported countermeasures – potentially in conjunction with the vulnerability– can comprise a reconfiguration of the network device, updating operational code of the network device, a recommendation to exchange the network device physically, installing a bug-fix a software update or similar actions.

And last but not least, the method 100 also comprises generating, at 110, an alert signal indicative of the device security vulnerability status. Optionally, the alert signal may only be generated if one or more vulnerabilities exist for the network device. In case a plurality of networked devices may be checked for vulnerabilities, the report may only comprise identifiers of those network devices comprising a vulnerability. The alert may also indicate that the same vulnerability could exist on many different network devices. Or the alert may indicate that one type of network device has one vulnerability, and that the type of network device is used several times in the network. The alert may have different levels of criticality based on the severity of the vulnerability identified. The alert may have a prioritizing proposal of which vulnerability to be fixed first.

FIG. 2 shows a flowchart of a method 200 of a first part of a more detailed flow diagram. Firstly, input data 202 are received in the form of Common Vulnerability and Exposure (CVE) data with an associated release date and end date of its validity. Additional data received includes a potential vulnerability inventory and/or an associated device list of network devices. Before receiving the CVE data, these data are requested, 204, from a source providing data about known vulnerabilities, e.g., the manufacturer of the network device or another public source, and returned, 206, to the requestor based on a given end date.

Next, the CVE data is filtered, 208, based on a predefined criticality. I.e., exposures or vulnerabilities with a higher criticality are used for vulnerability checks with a higher priority. Next, the CVE data are filtered, 210, based on software and hardware criteria or characteristics. Then, a final list of CVEs for a specific computing environment, i.e., network, is created, 212. Then, after a request has been generated, the requested content regarding potential vulnerabilities and details about it is returned, 216, in a machine-readable format, e.g., in JavaScript Object Notation (JSON) to the requestor, 214. The requested details can originate from the same source as the initial data about potential exposures and/or vulnerabilities.

In a subsequent step, the JSON documents are parsed and data that are important for a vulnerability check are extracted, 218. All found and extracted CVE data are then summarized, e.g., as device list, 220. This flowchart is continued with FIG. 3.

FIG. 3 shows a flowchart of a method 300 of a second portion of the more detailed flow chart of FIG. 2. Continuing the flowchart method 200 from FIG. 2, the process cycles through the device list, 302.

A component denoted as remote worker, which may be a part of a vulnerability checking engine, is activated in the network under investigation. A connection is established, 304, e.g., from the device security system which may execute the vulnerability check. This remote worker connects itself to the network device(s) under check and operating system (OS) version data are collected, 306. These received data are filtered, 308, against software and hardware criteria. Optionally, the device list can be updated if the respective device is eligible for an online vulnerability check, 310.

If the network device is eligible for the online vulnerability check – case “Y” of determination 312 – the process continues with the steps from step 310 onwards. Otherwise – case “N” of determination 312 – the process returns back to cycling through the device list, at 302, and selects the next network device in the device list. If the network device is determined to be eligible, the network device list is updated, 314. Here, the process continues with FIG. 4.

FIG. 4 shows a flowchart of a method 400 of a third portion of the more detailed flow diagrams of FIGS. 2 and 3. At connection point “B” the process continues with cycling the commands execution per network device, 402. Again, a connection to the remote worker in the network under security check (here, in the customer’s on-premise network) is established, 404, and a connection to the network device under check is established. This creates a collection of the executed command output, 406. Then it is determined, 408, whether the network device has vulnerabilities, depending on the data collected and output created by the execution of the command. A respective network device list is updated with the status associated with the command output, 410. If the last network device in the device list is reached – case “Y” in the determination 412 – the process ends at 414. Otherwise – case “N” – in the determination 412, the process cycles back – in particular, via a connection point “A” – to the portion of the flowchart in FIG. 3, in particular, to the activity cycling through the device list, 302.

FIG. 5 shows a block diagram of an architecture of a computing environment 500 to execute the inventive method 100. The network of computing devices 502 – in particular, servers, end-user devices (ED), and/or any other peripherical device (collectively denoted via reference number 504), like printers etc., are connected and supported through the network 506 with dedicated network connections 508. The network 506 itself comprises a plurality of network devices, comprising gateways, switches, and routers. Additionally, dedicated firewalls may also be components of the list of network (NW) devices 510. The above-mentioned remote worker can be executable by any device of the network 506. This may also be one of the servers 504 or another dedicated device.

It also be noted that the remote worker 518 may – in one way or another – be integrated into the network 506. The remote worker may be executed on the dedicated device or it may be part of one of the routers, switches, gateways and/or firewalls, i.e., a portion of one of the network devices 510. On the other side, i.e., the side from which the one vulnerability checks are controlled, a main worker 516 may remotely be connected (520) to the remote worker 518 in the network 506.

On the other side, a vulnerability search unit 512 which may also be the inventive device security system can establish a remote connection 520 to the remote worker 518 in the network 506. Based on this hardware-oriented set up, the vulnerability search unit 512 may execute the proposed method 100 and/or the more detailed methods 200, 300, and 400 with accessing a source of known potential vulnerability data 514.

FIG. 6 shows a block diagram of an embodiment of the device security system 600 (or in other words, the vulnerability searching unit 512 according to FIG. 5) for a security validation of a network device in a net-worked computing environment. The system comprises one or more processors 602 and a memory 604, communicatively coupled to the processor 602, where the memory 604 stores program code portions that when executed, enable the one or more processors 602, to receive – in particular using a receiver 606 – information about a security vulnerability of a network device, to filter – in particular, using the filter unit 608 – the received information to identify a specific security vulnerability associated with the network device and to extract – in particular using the extractor 610 – a command based on the filtered information, where a returned response of the command when executed is indicative of a specific vulnerability impacting an operation of the network device.

Furthermore, the one or more processors may also be enabled to generate – in particular using the report generator 612 – a report specifying at least one detail of the network device being affected by a known vulnerability, and to generate – in particular, using the alert generator 614 – an alert signal indicative of the device security vulnerability status.

It shall also be mentioned that all functional units, modules and functional blocks – in particular, the one or more processors 602, the memory 604, the receiver 606, the filter unit 608, the extractor 610, the report generator 612 and the alert generator 614 – may be communicatively coupled to each other for signal or message exchange in a selected 1:1 manner. Alternatively, the functional units, modules and functional blocks can be linked to a system internal bus 616 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read - only memory (ROM), erasable programmable read - only memory (EPROM or Flash memory), static random access memory (SRAM), compact disc read - only memory (CD - ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de - fragmentation or garbage collection, but this does not render the storage device as transitory because the data is not transitory while it is stored.

FIG. 7 shows a computing environment 700 comprising an example of an environment for the execution of at least some of the computer code involved in performing the inventive methods, such as the code block 750, i.e., network device security validation 750 which performs a computer-implemented method for security validation of a network device in a networked computing environment 700.

In addition to block 750, computing environment 700 includes, for example, computer 701, wide area network (WAN), end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer - implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip”. In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer - implemented method, such that the instructions thus executed will instantiate the methods specified in flowcharts and/or narrative descriptions of computer - implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction paths that allow the various components of computer 701 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and /or directly to persistent storage 713. Persistent storage 713 may be a read only memory (ROM), but typically at least a portion of the persistent storage allows writing of data, deletion of data and re - writing of data. Some familiar forms of persistent storage include magnetic disks and solid-state storage devices. Operating system 722 may take several forms, such as various known proprietary operating systems or open source Portable Operating System Interface type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (e.g., embodiments that utilize software - defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non - local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on - demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating - system - level virtualization. This refers to an operating system feature in which the kernel allows the existence of multiple isolated user - space instances, called containers. These isolated user - space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

It should also be mentioned that the device security system 600 for a security validation of a network device in a networked computing environment can be an operational sub-system of the computer 701 and may be attached to a computer-internal bus system. For instance, in at least one embodiment, the device security system 600 may be an operational sub-system within persistent storage 713 of computer 701.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for security validation of a network device in a networked computing environment, the method comprising:
receiving information about a security vulnerability of the network device;
filtering the received information to identify a specific security vulnerability associated with the network device;
extracting a command based on the filtered received information, wherein a returned response of the command when executed is indicative of a specific vulnerability impacting an operation of the network device;
generating a report specifying at least one detail of the network device being affected by a known vulnerability; and
generating an alert signal indicative of a security vulnerability status of the device.

2. The method of claim 1, wherein the networked computing environment comprises a plurality of network devices, and wherein the receiving, the filtering, the extracting, generating the report, and generating the alert signal is performed for each network device of the plurality.

3. The method of claim 2, wherein the network device or the plurality of network devices contains at least one out of the group comprising a router, a switch, and a firewall.

4. The method of claim 1, wherein the specific vulnerability impacting the operation of the network device is associated with a feature of an operating system of the network device.

5. The method of claim 1, further comprising:
receiving the information about the security vulnerability from a vendor of the network device or a trusted public source.

6. The method of claim 1, wherein the receiving, the filtering, the extracting, generating the report, and generating the alert signal is performed using a vulnerability checking engine operated remotely with respect to the networked computing environment.

7. The method of claim 1, further comprising:
executing the command using an application programming interface of the networked device.

8. The method of claim 2, wherein execution of the command is performed in parallel for each network device of the plurality of network devices.

9. The method of claim 1, wherein a separate document exists for each identified vulnerability of a plurality of security vulnerabilities.

10. The method of claim 1, wherein network devices of the networked computing environment are located in at least two different geographic locations.

11. A device security system for security validation of a network device in a networked computing environment, the system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving information about a security vulnerability of the network device;
filtering the received information to identify a specific security vulnerability associated with the network device;
extracting a command based on the filtered received information, wherein a returned response of the command when executed is indicative of a specific vulnerability impacting an operation of the network device;
generating a report specifying at least one detail of the network device being affected by a known vulnerability; and
generating an alert signal indicative of a security vulnerability status of the device.

12. The device security system of claim 11, wherein the networked computing environment comprises a plurality of network devices, and wherein the receiving, the filtering, the extracting, generating the report, and generating the alert signal is performed for each network device of the plurality.

13. The device security system of claim 12, wherein the network device or the plurality of network devices contains at least one out of the group comprising a router, a switch, and a firewall.

14. The device security system of claim 11, wherein the specific vulnerability impacting the operation of the network device is associated with a feature of an operating system of the network device.

15. The device security system of claim 11, further comprising:
receiving the information about the security vulnerability from a vendor of the network device or a trusted public source.

16. The device security system of claim 11, wherein the receiving, the filtering, the extracting, generating the report, and generating the alert signal is performed using a vulnerability checking engine operated remotely with respect to the networked computing environment.

17. The device security system of claim 11, further comprising:
executing the command using an application programming interface of the networked device.

18. The device security system of claim 12, wherein execution of the command is performed in parallel for each network device of the plurality of network devices.

19. The device security system of claim 11, wherein a separate document exists for each identified vulnerability of a plurality of security vulnerabilities.

20. A computer program product for a security validation of a network device in a net-worked computing environment, the computer program product comprising one or more computer readable storage medium and program instructions stored on at least one of the one or more computer readable storage medium, the program instructions executable by a processor capable of performing a method, the method comprising:
receiving information about a security vulnerability of the network device;
filtering the received information to identify a specific security vulnerability associated with the network device;
extracting a command based on the filtered received information, wherein a returned response of the command when executed is indicative of a specific vulnerability impacting an operation of the network device;
generating a report specifying at least one detail of the network device being affected by a known vulnerability; and
generating an alert signal indicative of a security vulnerability status of the device.
